(19) United States
(12) Patent Application Publication
(10) Pub. No.: US 2004/0100366 A1
(43) Pub. Date: May 27, 2004

(54) Tactile rhythm generator

(76) Inventor: Christopher V. Parsons, San Antonio, TX (US)

Correspondence Address: WAYNE J COLTON INC, THE MILAM BUILDING SUITE 1032, 115 EAST TRAVIS STREET, SAN ANTONIO, TX, 78205, US

(21) Appl. No.: 10/306,262

(22) Filed: Nov. 27, 2002

(51) Int. Cl. H04B 3/36

(52) U.S. Cl. 340/407.1

(57) ABSTRACT

A tactile rhythm generator comprises a signal generator for producing an electrical signal according to a rhythmic pattern; a tactile transducer in electrical communication with the signal generator, the tactile transducer being adapted to produce a tactile stimuli according to the rhythmic pattern; and a fastener associated with the tactile transducer and adapted to securely affix the tactile transducer to a portion of the person's body. The tactile transducer may comprise a piezoelectric device, a buzzer, electrodes or any other substantially equivalent device. The fastener may comprise a strap, which may be adapted to integrally contain the signal generator and tactile transducer. A programming interface, such as a personal computer or keypad and display combination, is preferably provided for specifying the rhythmic pattern.

### FIELD OF THE INVENTION

The present invention relates to methods and apparatus for rhythmic conditioning. More particularly, the invention relates to a method and apparatus for generating user determinable rhythmic patterns and, thereafter, imparting the patterns to an athlete or medical patient through a tactile transducer.

### BACKGROUND OF THE INVENTION

Metronome-like technology has recently been shown to help children with attention problems improve their attention, learning, motor planning and sequencing capabilities. Likewise, metronome-like technology has recently been shown to facilitate athletic training, the technology being useful in helping athletes develop pacing for track and field type events and rhythm for swinging of golf clubs and the like. Unfortunately, the foregoing uses have heretofore relied upon traditional type metronomes, which are limited to providing an audio or visual output signal. As a result, because in many athletic or therapy environments audio cannot be heard and visual attention may not be diverted, the athlete or patient has been required to essentially study a pattern and, thereafter, attempt to mimic the pattern absent direct input from the metronome.

It is therefore an overriding object of the present invention to improve over the prior art by providing a programmable metronome with a tactile output that is compact and rugged in implementation such that an athlete or patient may readily wear and utilize the metronome during actual practice for an athletic event or actual conduct of a physical therapy. Additionally, it is an object of the present invention to provide such a tactile metronome that is economical to manufacture, easy to use and widely programmable to a variety of complex output rhythms and/or patterns.

### SUMMARY OF THE INVENTION

In accordance with the foregoing objects, the present invention—a tactile rhythm generator—generally comprises a signal generator for producing an electrical signal according to a rhythmic pattern; a tactile transducer in electrical communication with the signal generator, the tactile transducer being adapted to produce tactile stimuli according to the rhythmic pattern; and a fastener associated with the tactile transducer and adapted to securely affix the tactile transducer to a portion of the person's body.

The tactile transducer may comprise a piezoelectric device, a buzzer, electrodes or any other substantially equivalent device. The fastener may comprise a strap, which may be adapted to integrally contain the signal generator and tactile transducer.

A programming interface, such as a personal computer or keypad and display combination, is preferably provided for specifying the rhythmic pattern.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS:

Although the scope of the present invention is much broader than any particular embodiment, a detailed description of the preferred embodiment follows together with illustrative figures, wherein like reference numerals refer to like components, and wherein:

FIG. 1 shows, in a functional block diagram, the preferred embodiment of the tactile rhythm generator of the present invention; and

FIG. 2 shows, in a perspective view, one embodiment of the tactile rhythm generator of FIG. 1 as utilized by a golfer in perfection of his golf swing.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

Referring now to the figures, the tactile rhythm generator 10 of the present invention is shown to generally comprise a signal generator 11 in electrical communication with a tactile transducer 16. As will be better understood further herein, the signal generator 11 is adapted to produce various rhythms and/or complex patterns. The signal generator 11 then communicates a generated rhythm and/or pattern through the tactile transducer 16 to a user. In this manner, as will also be better understood further herein, the tactile rhythm generator 10 may be utilized by a user, such as an athlete 20, to enhance sports acuity and/or accuracy and/or the like. Additionally, the tactile rhythm generator 10 of the present invention may also be utilized for therapeutic purposes such as, for example, assisting patients with neurological, muscular and/or neuromuscular disorders and/or physical injuries in their treatment and/or rehabilitation.

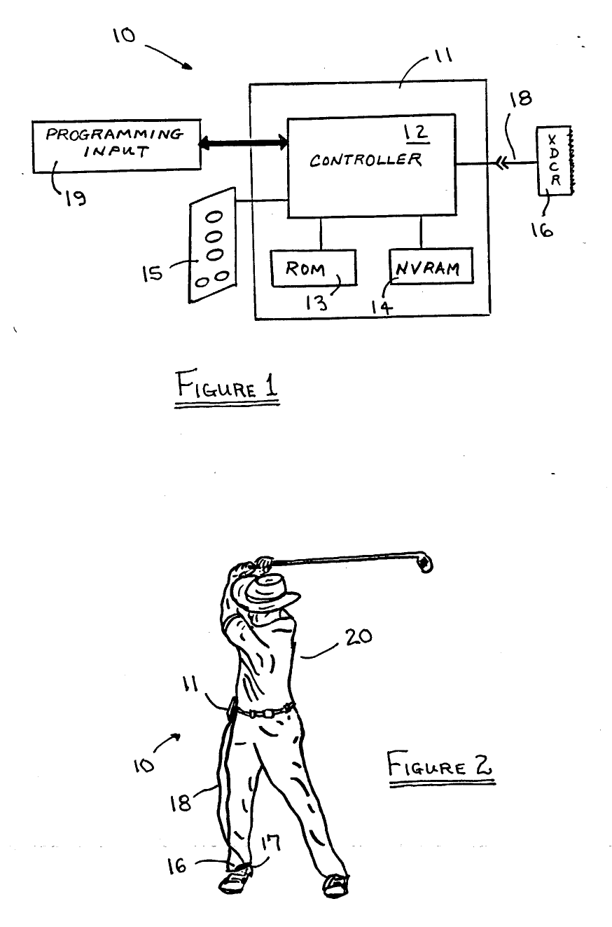

As particularly shown in FIG. 1, the signal generator 11 generally comprises a controller 12 with associated read only memory 13, non-volatile random access memory 14 and various additional implementation components as are readily within the grasp of those of ordinary skill in the art. As will be better understood further herein, the non-volatile random access memory 14 is utilized to store data defining the rhythm or pattern desired for a particular application of the tactile rhythm generator 10. In use, program instruction stored in the read only memory 13 is utilized by the controller 12 to generate an electrical output according to the data stored in the non-volatile random access memory 14. This output, in turn, is utilized by the tactile transducer 16, which may comprise a piezoelectric device, buzzer, set of electrodes or any other substantially equivalent device, to produce a tactile sensation corresponding to the rhythm or pattern.

As also shown in FIG. 1, a programming interface 19 is provided for initially communicating the desired rhythm or pattern to the signal generator 11. In particular, the user utilizes the programming interface 19, which may comprise a desktop or laptop computer, a keypad and display system or any other substantially equivalent system, to input the details of the timing of the desired rhythm or pattern into the non-volatile random access memory 14 of the signal generator 11. Preferably, the programming input 19 interfaces with the signal generator 11 through a bus cable connection, which is only connected during programming of the signal generator 11.

In use, an athlete 20 or other user, as depicted in FIG. 2, attaches the tactile transducer 16 to his or her ankle, wrist, chest or other area of the body as dictated by the physical activity in which the user will participate, utilizing an elastic or cloth material strap 17 integrally affixed thereto. The tactile transducer 16 is then electrically connected to the signal generator 11 through an electric cable 18. Control inputs 15 provided on the signal generator 11 are then utilized to commence generation of the desired rhythm or pattern. For example, a golfer may utilize the tactile rhythm generator 10 of the present invention to generate a simple, repeating “one-two” stimulation that the golfer may follow in perfecting his or her swing. Likewise, a high jumper might use a more complex pattern to time his or her accelerating footsteps on approach to the high jump.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, those of ordinary skill in the art will recognize, especially in light of his exemplary description, that it may be desirable to integrate the signal generator 11 and the tactile transducer 16 into a single, self-contained device integral with the strap 17. In this manner, the tactile rhythm generator 10 may be compactly and securely affixed to an athlete's wrist, ankle or other location without worry that the generator 10 will inadvertently be dropped or that the athlete 20 will become entangled in electric cables or the like. In any case, because the scope of the present invention is much broader than any particular embodiment, the foregoing detailed description should not be construed as a limitation of the scope of the present invention, which is limited only by the claims appended hereto.

What is claimed is:

1. A tactile rhythm generator for imparting tactile stimuli to a person according to a rhythmic pattern, said tactile rhythm generator comprising:
a signal generator for producing an electrical signal according to a rhythmic pattern;
a tactile transducer in electrical communication with said signal generator, said tactile transducer being adapted to produce tactile stimuli according to said rhythmic pattern; and
a fastener associated with said tactile transducer, said fastener being adapted to securely affix said tactile transducer to a portion of the person's body.

2. The tactile rhythm generator as recited in claim 1, wherein said tactile transducer comprises a piezoelectric device.

3. The tactile rhythm generator as recited in claim 1, wherein said tactile transducer comprises a buzzer.

4. The tactile rhythm generator as recited in claim 1, wherein said tactile transducer comprises electrodes.

5. The tactile rhythm generator as recited in claim 1, wherein said fastener comprises a strap.

6. The tactile rhythm generator as recited in claim 5, wherein said signal generator is integrated within said strap.

7. The tactile rhythm generator as recited in claim 1, said tactile rhythm generator further comprising a programming interface for specifying said rhythmic pattern.

8. The tactile rhythm generator as recited in claim 7, wherein said programming interface comprises a personal computer.

9. The tactile rhythm generator as recited in claim 7, wherein said programming interface comprises a keypad.

10. The tactile rhythm generator as recited in claim 9, wherein said programming interface further comprises a display.
